(19) United States
(12) Patent Application Publication
(10) Pub. No.: US 2018/0275852 A1
(43) Pub. Date: Sep. 27, 2018

(54) 3D PRINTING APPLICATION

(71) Applicants: Aaron Pettit, Manchester, TN (US); Dakota Carroll, Murfreesboro, TN (US)

(72) Inventors: Aaron Pettit, Manchester, TN (US); Dakota Carroll, Murfreesboro, TN (US)

(21) Appl. No.: 15/465,928

(22) Filed: Mar. 22, 2017

(51) Int. Cl. G06F 3/0481; G06F 3/0486; G09B 19/00; B33Y 50/02; B33Y 40/00

(52) U.S. Cl. CPC G06F 3/04815; G06F 3/0486; B33Y 40/00; B33Y 50/02; G09B 19/00

(57) ABSTRACT

A system for 3D imaging via a digital application that includes instructions on how to draft, draw, and the print a 3D tangible item. The system according to the present invention eliminates the need for drafting experience by offering a downloadable easy to use, application that teaches children as well as adults, via two-option platform, on how to develop and idea or image into a physical prototype. With the graphic abilities of 3D printing, the digital application will outline shape, model, color and layout principles in a quick clean format and then permit the user to manipulate these features to maximize their creativity using precise measurements

### BACKGROUND OF THE INVENTION

### Field of Invention

The present invention relates to a 3D printing application that provides a digital application to assist in drafting and printing a 3D image.

### Description of Related Art

3D printing relates to the development of 3D objects in a digital model through the use of a software application. Such application and techniques have been developed in the prior art. The prior art discusses various types of 3D printing options for many professionals. Once such disclosure is provided in U.S. Pat. No. 92,296,742 Tapley et al. (hereinafter “Tapley”). Tapley discloses a 3D printing system in the form of a printing service fulfillment in an online marketplace. This system of Tapley provides use of online access to 3D printing. Tapley hosts a 3D printing module that receives printing requests from users to request 3D printing and 3D object creation. A similar system is disclosed in U.S. Patent Publication No. 2015/0220748 to a Leach et al (hereinafter “Leach”). This system of Leach provides just another example of a 3D printing service for the marketplace environment.

The object of the present invention is to provide a 3D printing application through a digital application that provides printing but also instructs a person on how to draft, draw and imprint a 3D tangible object. The 3D printing application according to the present invention serves to eliminate the need for experience by offering an application that teaches children and adults in a two-way platform to develop an idea or image into a physical prototype. The present invention provides outline, shape, model, color and layout principles that help to clearly format and create the images with the minimum amount of experience from the user.

### SUMMARY OF THE INVENTION

A system for 3D imaging via a digital application that includes instructions on how to draft, draw, and the print a 3D tangible item. The system according to the present invention eliminates the need for drafting experience by offering a downloadable easy to use, application that teaches children as well as adults, via two-option platform, on how to develop and idea or image into a physical prototype. With the graphic abilities of 3D printing, the digital application will outline shape, model, color and layout principles in a quick clean format and then permit the user to manipulate these features to maximize their creativity using precise measurements

### DETAILED DESCRIPTION

The present invention relates to a 3D printing application that provides necessary software tools for 3D imaging and printing. The unique aspect of the present application is that the software is designed for a learning experience and provides a system that allows any user of any age to develop and create ideas into tangible physical objects. The application according to present invention is more time-efficient than traditional software such as AutoDessk. The present invention cuts the design time in half allowing users to be more flexible and creative with their ideas.

The application according to present invention allows a user to access all types of files within one platform without the use of a file converter as opposed to the prior art. Further users will not need to be overwhelmed with numbers and measurements needed for an exact model. The present invention sets exact measurements rather than running through and rushing through the artwork. The system also enables a database to store designs created by a user and provides publishing services to allow users to publish through a social media platform. The 3D imaging will be displayed through the social media platform through a live feed accessible to other users of the network. This allows users to share their creative works and create a marketplace for freelance artists. A fee-based system is implemented, where users pay a fee to post products in the marketplace but also to share designs and techniques with other users.

Certain aspects of the present invention include production tooling that includes a list of intelligence tools which are more precise and unique than the standard production tooling available. The tooling allows for the creation of geometrical parts not available through traditional modeling. Numerous other aspects of the invention provides for improved performance characteristics for the user such as speed, resolution, autonomous operation, ease of use, reliability and then a repeat-ability. Overall the system provides for faster production development for a novice user of a 3D printing application. Other features of the present invention include:
Back end extensible API's for each stage of the 3D printing workflow. These enable any business to quickly add 3D printing functionality to applications. With our back end, any application can prepare, optimize and deliver 3D models for any 3D printer or service bureau.
A set of industry standards for all aspects of the 3D printing ecosystem: software, hardware, materials and services. So a community of innovators can improve how things are made and even change the very nature of what we create.
Drag and Drop Queuing (Easy workflow management tools take the hassle out of complex projects)
Advanced plating (Automatically detect multiple parts with a single design file then individually manipulate, scale, rotate, and mirror those parts)
Collaborative Development (Allowing our users to work together where input may be provide by other input sources)
Seamless interoperability (This will allow our users to access any file types in 3D rendering technology)
3D to 2D (This allows the user to take their 3D project and convert it to 2D with a click of a button.)
Intergraded Rendering (a seamless rendering scale that allows the users to confidently work on their projects in real time and render 3D objects all in one motion.)
Cloud storage
VRML Import (Includes texture map import capabilities useful for color scan data, GIS data, FEA data, and color assemblies)
3D Printing Slicer (Slice 3D models allowing you to quickly and easily perform multiple iterations in order to achieve the best quality. The user can slice complex prints in mere seconds also while previewing the 3D part to identify potential areas of improvement.)
Smart Supports (Automatically generate support based on overhang angles and of legged corners. Then add or remove supports as needed. This tool allows the user to customize the placement size, and angle of support material. Also being able to snap off supports easily without damaging the part they are currently working on.)
Simplified Multi-Part Printing (Easily print multiple parts to save time and increase efficiency. This allows the user to quickly manipulate where parts are placed to make the most of the build space. With this the user will also have full control weather to print continuously layer by layer or sequentially)
Animated Preview (This feature allows the user to see exactly what his or her print will look like in complete first view. This will take away the hassle of having imperfect prints because you can see if anything is out of measurement.)
Smart Design invisible Center Lines/Center Marks (The user can now know where absolute center is without the annoying lines.)
Tool Buddy (All tools and design tools can be accessed through touch or click. Meaning no more annoying dialog boxes.)
Smart Dimensioning (Automatically create appropriate measurements based on the users drawing context. Pass the cursor or slide finger over selected objects to get a preview of the dimension.)
UI/AI (UI will provide the easiest use of tools and assets with just a click of a button or touch. The unique easy to use sleek design will provide our users with an ultimate enjoyable experience based on their profile setting. We are allowing our users to choose what they see and how it works. This gives them the power of creativity and provides the full dive system we have intergraded.) (Our AI can be used throughout the entire program allowing our users kids or adults to access any and all information that our program holds. It'll also have an high intel level meaning it can get to know its user and how they think.)
Stunning Visual Experience (Our users will be able to see the details in their designs more clearly with visual enhancements such as line fading. Our software features true curves instead of line segments which makes it easier to see and view full in depth data showed in real time.)
In-canvas Viewport Controls (The user can access viewport controls to change viewport settings, and visual styles directly on the viewport canvas instead of directing to a dialog box.)
Fail Safe Command System (Our users can access or undo a bad or incorrect command allowing them to not ever lose something completely)
Reality Computing (This allows our users to orient their work more precisely with our point information system. The user will be able to maneuver between horizontal and vertical planes more quickly with a dynamic UCS. Snap to edges, intersections, corners and centerlines to quickly create geometry using our point information system)
Curve Extraction (A cool feature to our tool system is the surface curve extraction tool. Extract isoline curves through a specified point on a surface of face of a solid to determine the definition lines of any shape. The tool displays a preview of resulting spline before you pick the point. The user can specify the direction of the isolines, either in the U or V direction.)
PressPull Tool (The user can extrude the offset curves, creating surfaces and solids. Use the multiple option to select multiple object within a single press pull option hands free. The users are no longer limited to clicking inside a boundary. Now they can select any rendered object hands free.)
3D to 2D Free-Form Tools (Our users can generate ideas in almost any form imaginable.

With Sapphire the user can access push/pull faces, edges, and vertices to model complex shapes and smooth surfaces. Solid, mesh, and surface modeling give you flexibility and control when designing in 3D. The hands free navigation bar includes frequently used tools such as steering wheels, view cube, and show motion, as well as pan zoom, and orbit.)
Surface Analyzing (Our user will be able to analyze the continuity, curvature, and draft of 3D solids and surfaces.)
Get Connected (Our software is designed to fit in the hands of children and adults to create extraordinary and creative designs. This can be done by bringing everyone together on all platforms. Our software can be accessed from mobile to PC/Mac. Our users at any given time can access their designs from anywhere.)
Polygon, Spline and 2D based modeling (Our users will be able to unleash their creativity with more than 70 unique hands free tools with a click of a button. As a user you'll be able to articulate minute details and optimize meshes for both interactive manipulation and rendering using subdivision surfaces and polygon smoothing.)
Text/Decal Creation (Our user will be able to create decals and text based graphics using just a quick scroll or slide of finger. With this you can also stay connected to the elements that remain interactive and linked to the original objects. Font changes, content revisions, and shape updates are reflected automatically with this new functionality. With this you wont have to leave the project to create new text or decals. You may make them within the same frame as your original project and or you can open a sub project layer if you as the user do not want to have your text immediately in frame. Once your done with your text you can highlight the 2D/3D rendered text/decal and drag it in and place it wherever you desire.)
Compositing (Our users can perform simple compositing operations within Sapphire with our height compositing tools. As a user you can expect to easily wire together rendered layers and passes, and combine them with compositing nodes like blends and color corrections in a schematic node-based interface. Any refinement can be edited and fixed within sapphire's walls.)

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A 3-D imaging system comprising:
a. Interactive software, where the interactive software provides a means to create 3-D imaging;
b. a user interface, where the user interface enables a user to access the interactive software;
c. a database for storage of user files;
d. a social media platform, where the social platform is accessible by all users.

2. The 3-D imaging system according to claim 1, where the social platform includes a live feed.

3. The 3-D imaging system according to claim 1, where the live feed includes a plurality of user files from a plurality of users.

4. The 3-D imaging system according to claim 1, where the interactive software includes a plurality of production tooling.

5. The 3-D imaging system according to claim 1, where the interactive software includes drag and drop queuing.

6. The 3-D imaging system according to claim 1, where the interactive software includes integrated rendering.

7. The 3-D imaging system according to claim 1, where the interactive software includes 3D to 2D conversion.

8. The 3-D imaging system according to claim 1, where the interactive software includes surface analyzing.
